(19) United States
(12) Patent Application Publication
(10) Pub. No.: US 2003/0222745 A1
(43) Pub. Date: Dec. 4, 2003

(54) Combination of transformer and coil

(75) Inventors: Cornelus Johannus Gijsbertus Spoorenberg, Nijmegen (NL); Erik Diderik De Vries, Nijmegen (NL); Stefan Wouter Blok, Nijmegen (NL)

Correspondence Address: BANNER & WITCOFF, 1001 G STREET N W, SUITE 1100, WASHINGTON, DC, 20001, US

(73) Assignee: Smit Transformatoren B.V., Nijmegen (NL)

(21) Appl. No.: 10/407,937

(22) Filed: Apr. 7, 2003

(30) Foreign Application Priority Data
Apr. 5, 2002 (NL) 1020316

(51) Int. Cl. H01F 27/28

(52) U.S. Cl. 336/170

(57) ABSTRACT

Combination of a transformer and at least one coil to be incorporated in an electricity distribution network, comprising:

at least one primary and one secondary transformer winding arranged on a transformer core placed in a housing,

at least one coil winding placed in the same housing and placed on a coil yoke, wherein the at least one coil winding is permanently connected inside the housing to at least one transformer winding, wherein the at least one coil winding can be switched off by a switch not directly connected to the at least one transformer winding. This configuration provides the option of placing the switch outside the housing at a location in the circuit where the short-circuit capacity is limited.

A transformer for an electricity distribution network comprises an assembly of a core and windings arranged thereon. The assembly is placed in a metal housing filled with oil. A coil, such as applied in electricity distribution networks, for instance for reactive current compensation, is also formed by a similar construction.

It is therefore attractive, when such a transformer and such a coil are present at the same location, to place them in the same housing. This is particularly the case when these components must be mutually connected.

When the two components are connected to the outside, a large number of bushings are required in the housing of the transformer, and these are expensive and form potential sources of disturbance.

In order to avoid these problems JP-A-6 116 014 proposes a combination of a transformer and a coil to be incorporated in a distribution network, comprising at least one primary and one secondary transformer winding arranged on a transformer core placed in a housing, a coil winding placed in the same housing and placed on a coil yoke and to be connected in parallel to the transformer winding, wherein the coil winding can be connected inside the housing to at least one transformer winding.

Although this prior art configuration greatly limits the number of bushings, this construction results in the drawback that the switches are placed in the transformer housing. This means that they are poorly accessible for maintenance and inspection, which is of great importance in the case of such switches. These problems are made even worse by the fact that the coil forms an inductive load, so that the switches will tend to form arcs.

Perhaps a more significant drawback is the fact that at the position of the switches the short-circuit capacity is only limited by the transformer winding. The switch and the winding must be dimensioned accordingly.

Known from JP-A-6 116 014 is a combination of a transformer and at least one coil to be incorporated in an electricity distribution network, comprising at least one primary and one secondary transformer winding arranged on a transformer core placed in a housing, and at least one coil winding placed in the same housing and placed on a coil yoke and connected in parallel to the transformer winding, wherein the at least one coil winding is permanently connected inside the housing to at least one transformer winding.

The coils are delta-connected and permanently connected to the transformer windings. They can be switched off by switches incorporated in the delta-connection and connecting to the nodes.

Here too there is the problem of the large short-circuit capacity because the switches are connected directly to the transformer winding.

The object of the present invention is to provide such a combination, wherein the short-circuit capacity is limited so that the diverse components of the combination need only be dimensioned for a smaller short-circuit capacity.

This objective is achieved with such a configuration, which is characterized in that the at least one coil winding can be switched off by a switch not directly connected to the at least one transformer winding.

This configuration provides the option of placing the switch outside the housing at a location in the circuit where the short-circuit capacity is limited.

It is noted here that a combination of a transformer and a coil is known from JP-A-2001-189220, wherein the coil winding is permanently connected to a transformer winding, wherein the coil winding can be switched off by a switch not directly connected to the coil winding. In this known combination the coil is connected in series to the transformer winding. There automatically ensues from this series connection a limitation of the short-circuit capacity independently of the position of the switch.

A first preferred embodiment of the invention provides the measure that the coil windings are star-connected and that the switch is placed between the neutral point and the coil winding.

In this embodiment the switches are placed in the neutral point where the short-circuit capacity is limited by the coil windings.

A second preferred embodiment teaches that the coil winding is divided into two pieces and that the switch is placed between the pieces.

This is a possible configuration wherein the short-circuit capacity is limited by those parts of the coil connected to the transformer winding. This will of course form a smaller limitation of the short-circuit current, but results in the possibility of a symmetrical configuration.

A particularly attractive embodiment teaches that the switch is placed outside the housing.

The accessibility of the switch is hereby greatly increased, wherein the number of bushings in the first embodiment is limited to three and in the second embodiment to six. The short-circuit capacity is moreover not only small at the switches, but also at the bushings.

Yet another preferred embodiment provides the measure that the transformer is provided with a tertiary winding and that the coil winding is connected to the tertiary transformer winding. Depending on the network configuration in which the combination is applied, this can be an attractive option; the switches present outside the housing are completely separated galvanically from the network.

Also depending on the network configuration, it may be attractive for the tertiary transformer winding to be delta-connected.

In the nomenclature used in this description and the appended claims, a winding is invariably understood to mean a multi-phase, in most cases a three-phase embodiment of the winding; the primary transformer winding is formed by three primary coils, one coil for each phase.

The application of the invention to systems with a different number of phases, for instance one phase as in capacity supply systems for railways in for instance Germany and Switzerland, is however by no means precluded.

The present invention will be elucidated hereinbelow with reference to the annexed figures, in which;

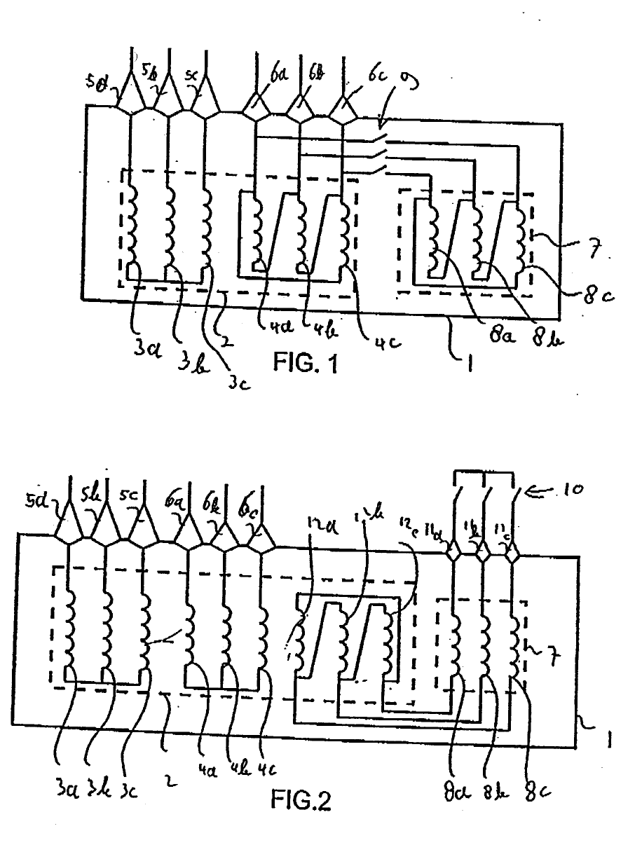

FIG. 1 shows a circuit diagram of a prior art combination of a transformer and a coil;

FIG. 2 shows a diagram of a first embodiment of a combination according to the invention, wherein a tertiary transformer winding is applied;

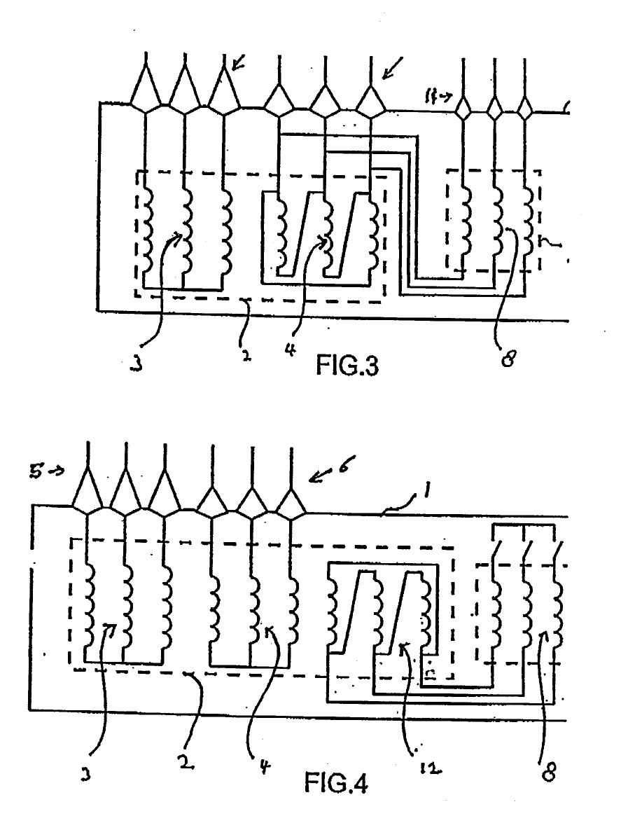

FIG. 3 shows a diagram of another embodiment of a combination according to the invention, wherein the coil is connected to the secondary transformer winding;

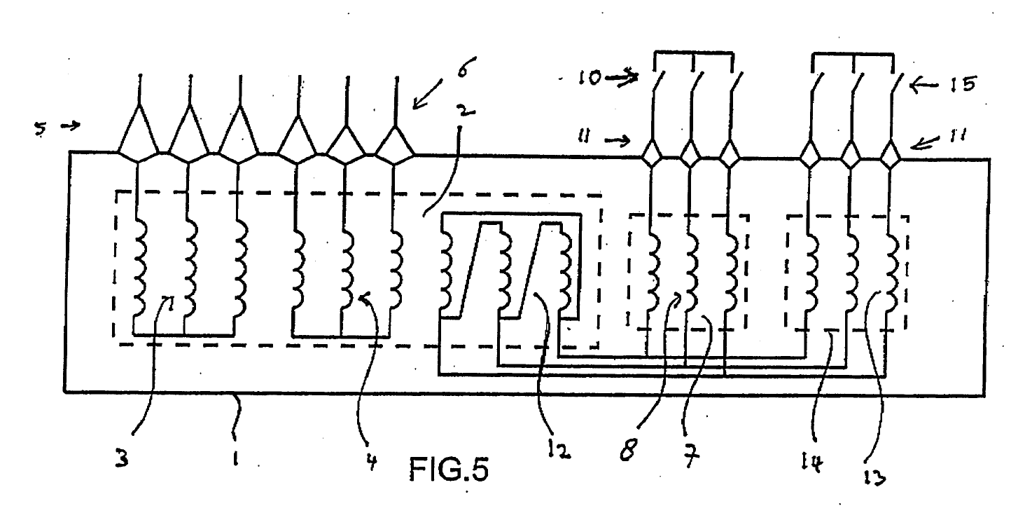

FIG. 4 shows a diagram of the embodiment of FIG. 2, wherein the switch is placed inside the housing;

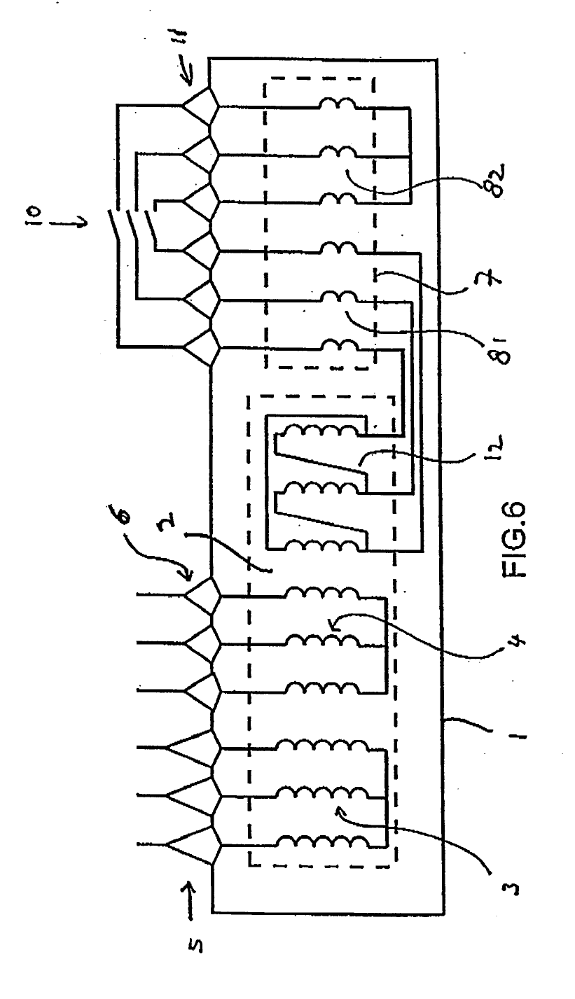

FIG. 5 shows a diagram of an embodiment wherein two coils connected in parallel are connected to the transformer winding;

FIG. 6 shows a diagram of the embodiment of FIG. 2, wherein the switch is received between divided coils; and

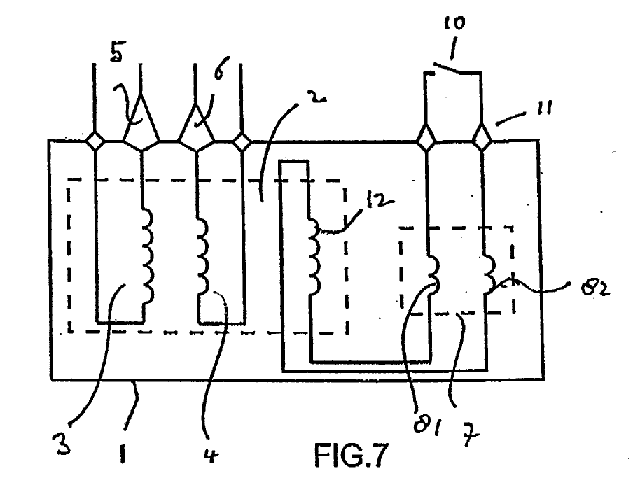

FIG. 7 shows a diagram of a single-phase embodiment of the invention.

FIG. 1 shows a housing 1 in which is placed a transformer core which is represented in FIG. 1 by a dotted line rectangle 2. A winding 3a, 3b, 3c respectively is arranged on the transformer core for each of the three phases. This high-voltage winding 3a, b, c is star-connected. Further arranged on transformer core 2 is a low-voltage winding 4a, 4b, 4c respectively which is delta-connected.

The high-voltage winding 3a, b, c is connected to the outside by means of three high-voltage bushings 5a, 5b, 5c respectively. The low-voltage winding 4a, b, c is connected to the outside by means of three low-voltage bushings 6a, 6b, 6c respectively.

Further arranged in housing 1 is a coil yoke 7 on which is placed a three-phase winding 8a, 8b, 8c respectively. This coil winding 8a-c is delta-connected. Coil winding 8 is connected to low-voltage winding 4 by means of a triple switch 9.

This prior art configuration has the advantage of the combination of transformer and coil accommodated in one housing, moreover has the advantage of a limited number of bushings, but has the drawback of a switch 9 arranged inside the housing 1 and the large short-circuit capacity at the position of the switch.

The first embodiment of the present invention shown in FIG. 2 makes use of a switch 10 arranged outside housing 1. This triple switch 10 is connected by means of bushings 11a, 11b, 11c respectively to windings 8a, 8b, 8c respectively of the coil. The coil winding 8a, 8b, 8c is star-connected via switch 10.

This embodiment has the further advantage that the coil is connected to a tertiary winding 12a, 12b, 12c respectively of the transformer, so that all parts connected galvanically to bushings 11a, 11b, 11c are electrically floating relative to the network. This contributes toward a decreased load on the bushings.

FIG. 3 shows an embodiment wherein the tertiary winding 12 is omitted and coil winding 8 is connected directly to the low-voltage or secondary winding 4. This results in a significant saving of material although, compared to the circuit shown in FIG. 2, this circuit has the drawback that the mains voltage of the low-voltage network is coupled to triple switch 10.

Although this will not cause a problem in normal situations because the bushings form only one connection to the neutral point, it can however result in high voltages over the voltage bushings in the case of asymmetrical loads and other abnormal situations. These will therefore have to be dimensioned accordingly.

Although not directly recommended, it is also possible to accommodate the switch 10 inside the housing. While the bushings and the associated problems are herein avoided, the accessibility of switch 10 is herein sacrificed. Such a configuration is shown in FIG. 4.

The coils are generally used for reactive current compensation. It is attractive if the value of the reactive current compensation can be varied independently of the conversion ratio of the transformer. It is possible for this purpose to connect a plurality of coils to the transformer. The coils can then be switched on and off as required. FIG. 5 shows an embodiment of such a circuit. This embodiment comprises two coils 8, 13 which are placed on a yoke 7, 14 respectively and which can each be switched on and off individually by switches 10, 15 respectively. Although the figure shows that the coils are each placed on their own yoke, it is also possible to place the coils together on one yoke.

It is also attractive if the values of the coils are unequal; multiple values can be obtained by selective switch-on and switch-off.

It is not only possible to place the switch in the neutral point; the coils can be divided, whereafter the switch can be placed between the thus obtained coil halves. Such a configuration is shown in FIG. 6. Coils 8 are divided into coil halves 81 and 82. Switch 10 is herein placed between coil halves 81 and 82.

Finally, FIG. 7 shows a single-phase configuration; no neutral point is present here. It is of course possible to place the switch 10 between transformer winding 12 and the coil winding.

When the coil is connected to a tertiary transformer winding, this brings about the advantage of the invention; a smaller short-circuit capacity, because the short-circuit current is bounded by the tertiary transformer winding and the coil, independently of the position of the switch in the circuit.

When the coil is connected to the secondary transformer winding, the advantage of the invention is not achieved when the switch is connected directly to the transformer. In this configuration it is thus necessary to divide the coil 8 into two pieces 81 and 82 and to place switch 10 between the two pieces 81,82.

It will be apparent that diverse variations of the shown embodiment are possible; star-connection of tertiary winding 12a-c is thus possible for instance, or delta-connection of coil winding 8a-c.

1. Combination of a transformer and at least one coil to be incorporated in an electricity distribution network, comprising:
at least one primary and one secondary transformer winding arranged on a transformer core placed in a housing,
at least one coil winding placed in the same housing and placed on a coil yoke and to be connected in parallel to the transformer winding, wherein the at least one coil winding is permanently connected inside the housing to at least one transformer winding, characterized in that the at least one coil winding can be switched off by a switch not directly connected to the at least one transformer winding.

2. Combination as claimed in claim 1, characterized in that the transformer is a multi-phase transformer, that at least one coil winding is star-connected and that the switch is placed between the neutral point and the coil winding.

3. Combination as claimed in claim 1 or 2, characterized in that the at least one coil winding is divided into two pieces and that the switch is placed between the two pieces.

4. Combination as claimed in claim 1, 2 or 3, characterized in that the switch is placed outside the housing.

5. Combination as claimed in any of the foregoing claims, characterized in that the transformer is provided with a tertiary winding and that the coil winding is connected to the tertiary transformer winding.

6. Combination as claimed in claim 5, characterized in that the tertiary transformer winding is delta-connected.

7. Combination as claimed in any of the foregoing claims, characterized in that the at least one coil comprises two windings.

8. Combination as claimed in claim 7, characterized in that the windings have a differing value.
